(19) United States
(12) Patent Application Publication
(10) Pub. No.: US 2016/0171780 A1
(43) Pub. Date: Jun. 16, 2016

(54) COMPUTER DEVICE IN FORM OF WEARABLE GLASSES AND USER INTERFACE THEREOF

(71) Applicant: Neorai Vardi, Mevaseret Tzion (IL)

(72) Inventor: Neorai Vardi, Mevaseret Tzion (IL)

(21) Appl. No.: 15/044,565

(22) Filed: Feb. 16, 2016

Related U.S. Application Data
(63) Continuation-in-part of application No. 13/911,396, filed on Jun. 6, 2013.
Application No. 13/911,396 is a continuation-in-part of application No. 13/366,322, filed on Feb. 5, 2012, now abandoned.
(60) Provisional application No. 61/504,210, filed on Jul. 3, 2011.

(51) Int. Cl. G06T 19/00; G02B 27/01; G06F 3/00; G06F 3/01; G06F 3/0488

(52) U.S. Cl. CPC G06T 19/006; G06F 3/014; G06F 3/04886; G06F 3/005; G02B 27/017; G02B 2027/0178

(57) ABSTRACT

A computer device that is configured as wearable glasses and a user interface thereof, which comprises a transparent optical lens adapted to display, whenever desired, visual content on at least a portion of the lens, for enabling a user wearing the glasses to see the visual content, wherein the lens enables a user to see therethrough, in an optical manner, also a real-world view; a wearable frame for holding the lens and a portable computerized unit for generating the visual content and displaying or projecting the visual content on the portion, wherein the computerized unit is embedded within the frame or mounted thereon.

The current application is a continuation-in-part of U.S. patent application Ser. No. 13/911,396 filed on Jun. 6, 2013, which is a continuation-in-part of U.S. patent application Ser. No. 13/366,322 filed on Feb. 5, 2012, which claims priority from U.S. Provisional Patent Application No. 61/504,210 filed on Jul. 3, 2011, incorporated herein by reference.

### FIELD OF THE INVENTION

The present invention relates to the field of computer devices and user interfaces thereof. More particularly, the invention relates to a user interface for a computer device that is configured as wearable glasses.

### BACKGROUND OF THE INVENTION

The term user interface refers to facilities and functionality for allowing interaction between a human user and a computerized machine. The purpose of a user interface is to allow a human user to monitor and/or control the computerized machine. For these purposes, a user interface may include inputting facilities such as a keyboard and mouse, and/or to display the output from the computer, such as video signals and audio signals.

Video glasses (also known as data glasses or a visor) are a recently developing output facility. It comprises two displays, embedded in a glasses form device. Thus, a user that wears video glasses can watch a video display, such as a movie. Video glasses are common as an output device for video games and military simulators. However, when a human user wears such glasses there is an obstacle to using a keyboard with hands or to perform other tasks, as these video glasses block the vision therethrough.

There is a growing need for users of computerized wearable glasses to share a viewed object with others, and it would be desirable to provide means for selecting a viewed object by a pointing gesture.

U.S. Pat. No. 6,222,465 discloses a system and method for manipulating virtual objects in a virtual environment. A display is provided to display the virtual environment, and a video gesture recognition subsystem is used to identify motions and gestures of a user's hand, including a pointing gesture. However, means are not provided for selecting and sharing a viewed real world object.

It is an object of the present invention to provide a solution to the above-mentioned and other problems of the prior art.

Other objects and advantages of the invention will become apparent as the description proceeds.

### SUMMARY OF THE INVENTION

In order to facilitate the reading to follow, the following terms are defined:

The terms “desktop computer”, “computer device” or shortly “computer” refer herein to any computer that employs a user interface comprising an output facility such as a display and input facility in the form of an alphanumeric keyboard, whether real or virtual.

The present invention is directed to a method for communicating visual information, comprising the steps of bodily mounting a pair of computerized glasses comprising a computerized unit, a forwardly directed camera which is in short-range data communication with said portable computerized unit, and communication equipment in short-range data communication with said computerized unit for defining a local reference point or reference plane; viewing a real-world object of interest; causing said computerized unit to identify said object by performing a pointing gesture, whereby at least two longitudinally spaced transmitters in short-range data communication with said computerized unit are positioned in such a way to define a vector with identifiable coordinates with respect to said reference point or plane and that is directed at said real-world object of interest; capturing an image of said object with said forwardly directed camera; and wirelessly transmitting said object over a communication channel from said computerized unit to a desired recipient.

The present invention is also directed to a computerized wearable glasses system for communicating visual information, comprising at least one transparent optical lens adapted to display, whenever desired, visual content on at least a portion of said lens, for enabling a user wearing said glasses to see said visual content, wherein said lens enables said user to see therethrough, in an optical manner, also a real-world view; a wearable frame for holding said at least one lens; a portable computerized unit for generating said visual content and displaying or projecting said visual content on said lens portion, wherein said computerized unit is embedded within said frame or mounted thereon; a forwardly directed camera which is in data communication with said portable computerized unit and which is embedded within or mounted on said frame, for capturing remote real-world visual information viewed through said at least one optical lens; an orientation determining component in data communication with said portable computerized unit, for locating a spatial position of said forwardly directed camera or of an element thereof, an element embedded within or mounted on said frame for establishing a connection between said computerized unit and a wireless interfacing communication channel, for wirelessly transmitting said captured real-world visual information; communication equipment in short-range data communication with said computerized unit for defining a local reference point or reference plane; and at least two longitudinally spaced transmitters in short-range data communication with said computerized unit which are positionable to define a vector with respect to said reference point or plane that is directable at a real-world object of interest.

Said computerized unit is responsive to orientation data of said forwardly directed camera received from said orientation determining component and to position data received from said at least two transmitters, to select and controllably adjust, when said at least two transmitters are arranged to point at said real-world object of interest, a field of view of said forwardly directed camera so as to include and lock onto said real-world object of interest even during subsequent movement of said user and to thereby capture real-world visual information that includes said object of interest. In addition, said captured real-world visual information is wirelessly transmittable over said communication channel to a desired recipient, is viewable by said recipient, whenever desired, and is changeable in response to said movement of said user.

According to one embodiment, the system further comprises a rear camera embedded within or mounted on the frame, such that multimedia information showing at least a portion of a face of the user is capturable and wirelessly transmittable to the desired recipient.

According to one embodiment, the system further comprises a projector embedded within or mounted on the frame, for projecting generated visual content on an essentially flat vertical surface in front of said computerized unit. The computerized unit, when positioned on a horizontal surface in front of the user in such a way that the rear camera captures the entire face of the user, is operable to transmit images of the face of the user to said projector so as to superimpose the face of the user on said generated visual content. Images of the face of the user superimposed on said visual content are transmittable via the communication channel to other videoconferencing participants.

According to one embodiment, the system further comprises at least one hand mounted sensor in data communication with the communication equipment for indicating a state and position of each of the fingers of the user, with respect to reference point or reference plane, so as to function as an input device for controlling operation of the forwardly directed camera and for selecting a destination to which the captured real-world visual information is to be transmitted.

According to an embodiment of the invention, the computer device further comprises a keyboard substitute which includes: a virtual keyboard (and/or other virtual input device, such as a computer mouse) displayed on said portion; and at least one sensor for indicating the state and position of each of the fingers of a user, with reference to an image that represent said virtual keyboard; thereby providing a user interface in the form of video glasses for the computer device.

According to an embodiment of the invention, the at least one sensor is embedded within a glove.

According to an embodiment of the invention, the computer device further comprises built-in earphones, connected to the wearable frame, for being used as an output facility of the computer device.

According to an embodiment of the invention, the computer device further comprises a microphone embedded in the wearable frame, for being used as an input facility to the computer device.

According to one embodiment of the invention, the computer device further comprises a pointing device (e.g., in form of a computer mouse or trackball) in a wired or wireless communication with the portable computerized unit.

According to yet another embodiment of the invention, a substantial part of the circuitry of the portable computerized unit is embedded in an external device, wherein said external device is connected to said computer device via a wired or wireless communication channel (e.g., I/O port, USB connection, Bluetooth, etc.).

According to an embodiment of the invention, the computer device may further comprise circuitry and/or computer code for analyzing human speech and translating thereof to computer instructions.

According to another embodiment of the invention, the computer device enable to see therethrough, in a digital manner, a real-world view (e.g., a camera allows to take a video stream and display or superimpose it on the lens).

According to one embodiment of the invention, the computer device adapted to generate stereoscopic images (i.e., a different image is displayed to each eye), thereby allowing presenting 3D images.

According to one embodiment of the invention, the computer device further comprises a projector, for projecting visual content generated by the portable computerized unit on an essentially flat surface in front of the computer device. According to an embodiment of the invention, the projected visual content includes at least one virtual input device such as a virtual keyboard and/or a virtual computer mouse.

According to one embodiment of the invention, the computer device further comprises at least one sensor for indicating the state and position of each of the fingers of a user, with reference to the projected virtual input device(s).

According to one embodiment of the invention, the computer device further comprise an I/O port (e.g., a USB connector and circuitry), for allowing connecting additional peripherals to said computer device (e.g., via the portable computerized unit).

According to one embodiment of the invention, the computer device further comprises a memory slot and circuitry, for allowing connecting a memory, such as a an electronic flash memory data storage device used for storing digital information, to said computer device.

According to one embodiment of the invention, the computer device further comprises at least one camera (whether stills or video), for inputting video signals. According to one embodiment of the invention the camera is a rear camera (i.e., internal camera) for transmitting multimedia information that shows at least portion of the face of the user wearing the computer device.

According to one embodiment of the invention, the computer device further comprises a cellular module (e.g., a cellular telephone circuitry), embedded in the wearable frame, thereby providing said computer device the ability of cellular communication (e.g., allowing using the computer device as a cellular telephone).

According to one embodiment of the invention, the computer device is powered by one or more rechargeable batteries, wherein said batteries can be recharged by solar energy via solar panel or manually via a charger with manual hand ankle.

According to one embodiment, the system further comprises at least one additional pair of glasses each of which is identical to, and remotely separated from, said computerized wearable glasses system, wherein said captured real-world visual information which is wirelessly transmittable is displayable on said at least one lens of each of said at least one additional pair.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a computer device that is configured as wearable glasses and a user interface thereof, according to one embodiment of the invention.

FIG. 2 schematically illustrates peripheral devices that can be connected to the computer device of FIG. 1, according to embodiments of the present invention.

FIG. 3 schematically illustrates further peripheral devices that can be connected to the computer device of FIG. 1, according to one embodiment of the invention.

FIG. 4 schematically illustrates a usage of the computer device of FIG. 1 as a part of a cellular telephone, according to one embodiment of the invention.

FIG. 5 schematically illustrates a front perspective view of computerized wearable glasses, according to one embodiment of the invention.

FIG. 6 schematically illustrates a plan view of the computerized wearable glasses of FIG. 5 and of a pointing rod during the selection and sharing of a real-world object viewed through the glasses.

FIG. 7 schematically illustrates a rear view of a portion of the computerized wearable glasses of FIG. 5 and of finger mounted transmitters during the selection and sharing of a real-world object viewed through the glasses.

FIG. 8 schematically illustrates a plan view of computerized wearable glasses according to another embodiment of the invention, for use by a user in transit during the selection and sharing of a real-world object viewed through the glasses.

It should be understood that the drawings are not necessarily drawn to scale.

### DETAILED DESCRIPTION OF THE EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

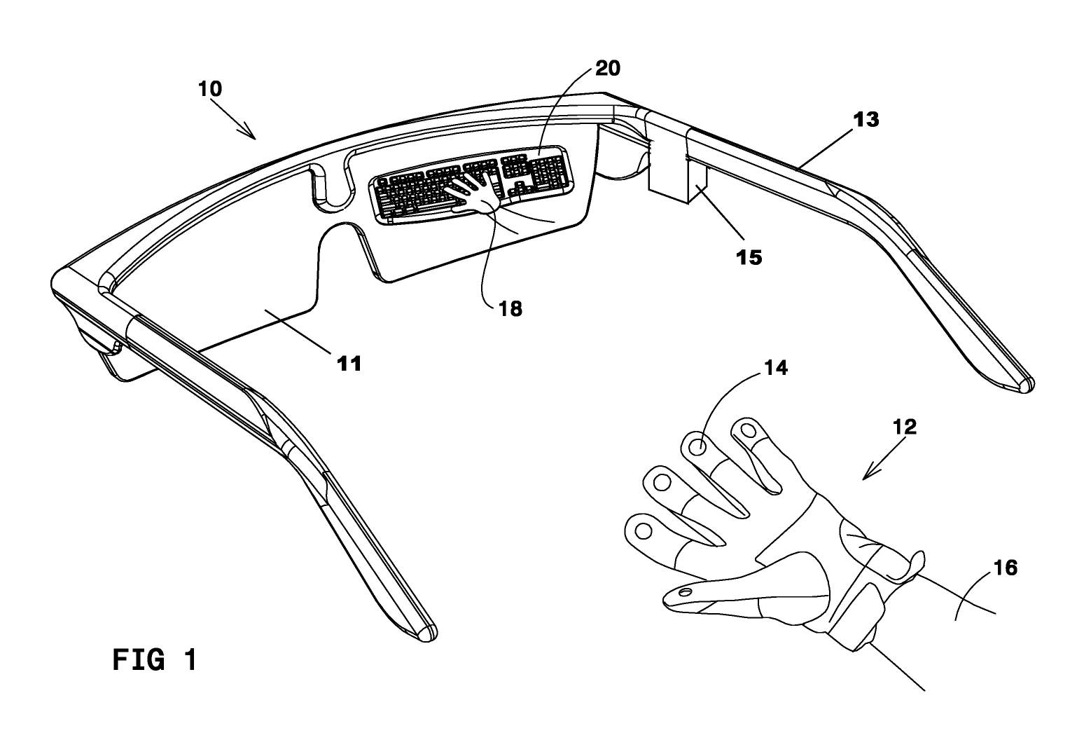

FIG. 1 schematically illustrates a computer device 10 that is configured as wearable glasses and a user interface thereof, according to one embodiment of the invention. The computer device 10 comprises: at least one transparent optical lens 11, a wearable frame 13 for holding lens 11 and a portable computerized unit 15.

The at least one transparent optical lens 11 adapted to display, whenever desired, visual content on at least a portion of lens 11, for enabling a user wearing the computer device 10 to see the visual content on the portion of the lens 11 that is directed to the user's eyes. In addition, lens 11 enables the user to see therethrough, in an optical manner, also a real-world view. The lens 11 is used as a display of the computer device 10.

Portable computerized unit 15 is used for generating the visual content and for displaying or projecting the generated visual content on the portion of lens 11. Portable computerized unit 15 can be embedded within the wearable frame 13 or mounted thereon as shown in the figures. According to one configuration (not illustrated), the portable computerized unit is embedded in the wearable frame 13. Of course, such configuration requires ultimate minimization of the components thereof. One of the temples of the wearable frame 13 may be used as a housing for batteries.

According to one embodiment of the invention, portable computerized unit 15 may include all the computer's components (e.g., graphic card, CPU, memory, etc.) required for generating the visual content and for displaying or projecting the generated visual content on the portion of lens 11. In this embodiment, portable computerized unit 15 combines the computer's components (e.g., in a suitable circuitry form) into the same wearable frame 13 that holds the lens 11. As will be appreciated by a person skilled in the art, portable computerized unit 15 may combine only part of the computer's components, as described in further details hereinafter.

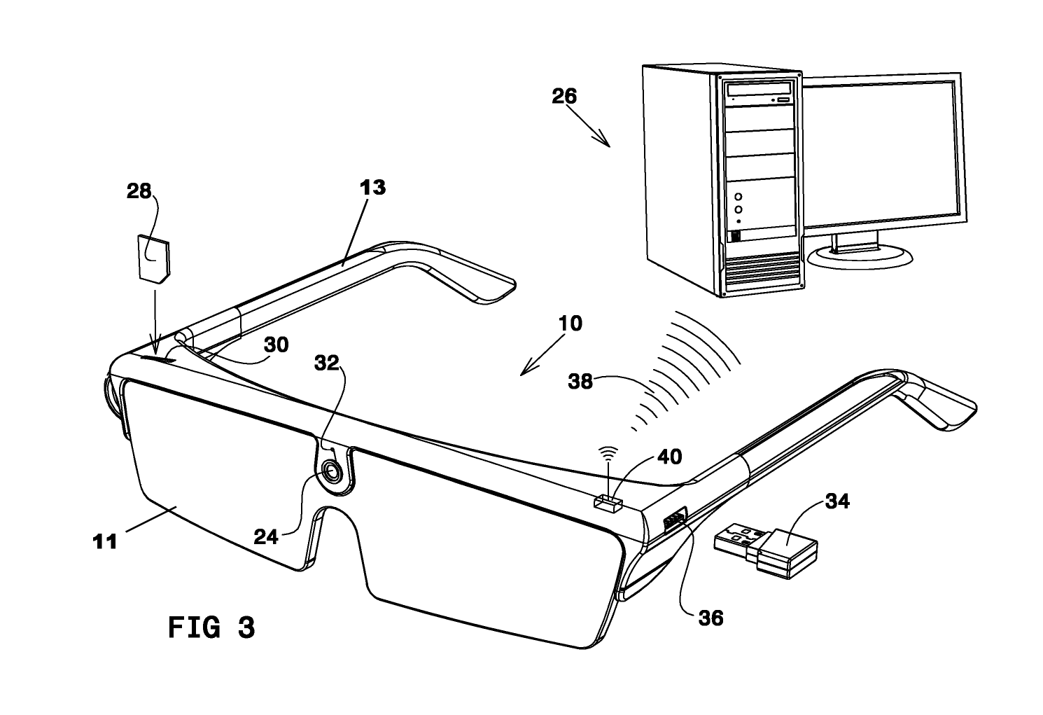

According to an embodiment of the invention, a substantial part of the circuitry of the portable computerized unit 15 is embedded in an external device (not shown). The external device is connected to the computer device 10 (i.e., to the corresponding circuitry of the portable computerized unit 15 that remains embedded with frame 13) via a wired or wireless communication channel (e.g., I/O port, USB connection, Bluetooth, etc.). For example, the external device can be implemented as a portable device (e.g., a desktop computer embedded in a chip in a similar manner as shown with respect to a portable device 34 in FIG. 3 hereinafter), or as a connection box (e.g., similar to a desktop computer 26 as shown with respect to FIG. 3 hereinafter).

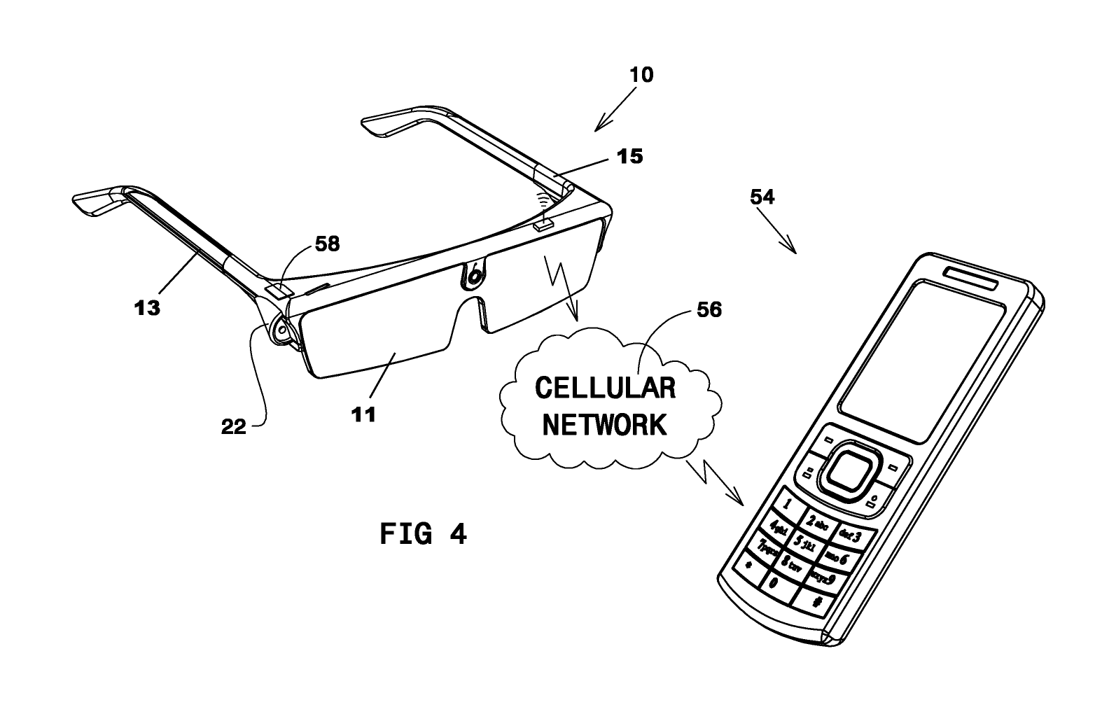

According to an embodiment of the invention, the computer device 10 further comprises a keyboard substitute which includes: a virtual keyboard 20 displayed on the portion of lens 11 (or projected as described hereinafter in further details with respect to projector 22 of FIG. 4), and at least one sensor 14 for indicating the state and position of each of the fingers of a user's hand 16, with reference to an image that represent the virtual keyboard 20. The keyboard substitute can provide a user interface in the form of video glasses for the computer device 10. As per the keyboard, as a user may not see the real world through prior-art video glasses, a “real” keyboard (i.e., tangible keyboard) cannot be useful.

For example, as a substitute to a real keyboard, computer device 10 displays (or projects) a virtual keyboard 20 and at least one virtual glove 18 (or alternatively other virtual pointing device, such as a virtual computer mouse). In addition, the user wears a real glove 12 on his palm, which comprises sensors 14 on each of the fingers thereof, for sensing (a) the state of each of the fingers of the glove, and (b) the absolute and/or relative position of each of the fingers thereof with reference to an imaginary keyboard (not illustrated).

As the user moves glove 12 with reference to the imaginary keyboard, the virtual glove 18 imitates this movement. As a user “hits” by the finger of the glove (e.g., performs a sudden movement downwards), the computer interprets this event as hitting the key of the virtual keyboard 20 at which the virtual finger of virtual glove 18 points. The display of the virtual glove 18 may animate the key hit, e.g., by a blink.

The imaginary keyboard may be embodied as a landmark device 62 placed in front of the user. The landmark device 62 and the glove 12 comprise circuitry for indicating the location of each of the sensors 14 on the glove 12 with reference to the landmark device 62.

It should be noted that if the landmark device 62 would have been a part of the computer device 10, the mechanism for indicating the location and state of each of the sensors 14 on the fingers of the glove 12 would have been more complicated, as the computer device is not stationary. A landmark device 62 placed in a stationary location simplifies the mechanism.

Although in the figures only one glove is displayed, according to a preferred embodiment of the invention, two gloves can be used, as typing on a keyboard is usually effected by two hands. Alternatively, the user may use sensors 14 without gloves (e.g., a sensor implemented as a wearable finger ring).

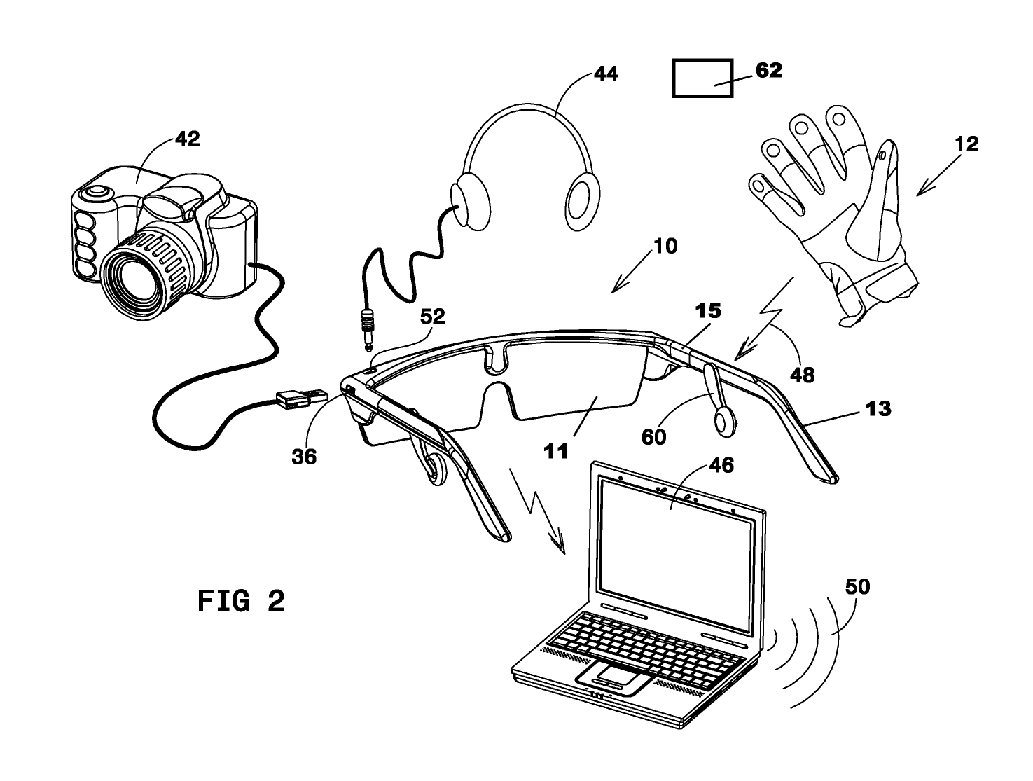

FIG. 2 schematically illustrates peripheral devices that can be connected to the computer device 10, according to embodiments of the present invention.

The computer device 10 may comprise built-in earphones 60, connected to the temples of frame 13.

Additionally or alternatively, the computer device 10 may comprise external earphones 44 connected to the computer device 10 through a corresponding connector 52 embedded within frame 13.

The computer device 10 may also comprise a USB (Universal Serial Bus) connector 36, through which a USB camera 42 and the like can be connected.

Glove 12 can communicate with the computer device 10 by Bluetooth communication 48.

Computer device 10 can be connected to a wireless network 50, to a laptop computer 46, and so on.

FIG. 3 schematically illustrates further peripheral devices that can be connected to the computer device 10, according to an embodiment of the invention.

A slot 30 on the frame of computer device 10 may be used for connecting external memory to computer device 10, and also therefrom (e.g., via a wired or wireless communication link) to a desktop computer 26 thereof.

According to one embodiment of the invention, computer device 10 further comprises a camera (whether stills or video), for inputting video signals. In this figure, an Internet camera 32 and built-in microphone 24 are connected to the front of the computer device 10, thereby allowing transmitting multimedia information sensed by the individual wearing the computer device 10. In other embodiment, an additional camera (not shown), can be connected to the internal side of computer device 10 (i.e., a rear camera), thereby allowing transmitting multimedia information that shows at least portion of the face of the individual wearing the computer device 10 (e.g., this can be used for videoconferencing).

FIG. 3 also schematically illustrates some configurations of a desktop computer system that employs the computer device 10.

According to a first configuration, the computer device 10 is a user interface output facility of desktop computer 26. For this purpose, the computer device 10 is connected with desktop computer 26 via RF (Radio Frequency) signal 38, such as Bluetooth communication, Wi-Fi communication, digital network interface for wireless High-Definition signal transmission (e.g., WirelessHD), and the like. Bluetooth is an open specification for short-range wireless communication between various types of communication devices, such as cellular telephones, pagers, hand-held computers, and personal computers. In such a configuration, the display of the desktop computer 26 can be replaced by the computer device 10. For example, such a configuration can be used as a media streaming system, where multimedia content from desktop computer 26 is streamed to computer device 10.

According to a second configuration, the desktop computer system is a portable device 34, which connects to the computer device via USB connector 36. In such a configuration, device 34 can be used instead of the portable computerized unit 15 of FIG. 1.

According to a third configuration (not illustrated), the desktop computer is embedded in the wearable frame 13. Of course, such a configuration requires ultimate minimization of the components thereof. One of the temples of the wearable frame 13 may be used as a housing for batteries. According to one embodiment, the batteries can be recharged by solar energy via a solar panel (not shown) or manually via a charger with a manual hand ankle such as the Sony CP-A2LAS Charger.

According to a fourth configuration (not illustrated), the computer device 10 is connected to desktop computer 26 by wired communication means.

FIG. 4 schematically illustrates a usage of computer device 10 as a part of a cellular telephone, according to one embodiment of the invention.

A cellular telephone circuitry (not illustrated) is embedded in the frame 13 of computer device 10. The cellular telephone circuitry uses the display of computer device 10 (i.e., lens 11), built-in microphone 24 and built-in earphones 60. Thus, a user wearing computer device 10 can engage in a cellular telephone conversation with a user of cellular telephone 54.

The cellular telephone embedded in computer device 10 communicates with cellular telephone 54 via cellular network 56.

Actually, cellular telephones are presently designed to perform operations of desktop computing, and vice versa. As such, there is no point in distinguishing between a cellular telephone that provides only telephone functionality and a cellular telephone that also provides functionality of a desktop computer.

According to one embodiment of the invention, computer device 10 may further comprise a projector 22, for projecting the visual content generated by the portable computerized unit 15 on an essentially flat surface (e.g., movies, media files or documents in front of the computer device). For example, in such configuration the computer device 10 can be used as a media streamer. Projector 22 may also be used to project visual content such as images that simulate the required devices to operate computer application manually, such as a virtual computer mouse (not shown), the virtual keyboard 20 described hereinabove with respect to FIG. 1, etc. For example, designated software adapted to recognize the user's hand(s) or fingers in a surface defined as an auxiliary device surface can be used. This can be done by using motion sensors backed by a configuration recognition software and/or surface locating and mapping for surface part software, while addressing the location of the projected virtual mouse (or virtual keyboard) and translating them for various operations commands for the computer device 10.

In the figures and/or description herein, the following reference numerals have been mentioned:
numeral 10 denotes computer device in form of wearable glasses, used as a computer and a display thereof;
numeral 11 denotes a transparent optical lens;
numeral 12 denotes a glove having thereon sensors 14;
numeral 13 denotes a wearable glasses frame;
numeral 14 denotes a sensor (either on a finger of glove 12 or not), used for indicating the position (i.e., on which key of a keyboard it points) and state (pressed or not) thereof;
numeral 15 denotes a portable computerized unit;
numeral 16 denotes a user's hand;
numeral 18 denotes a virtual glove (or palm) displayed on a display of computer glasses 10;
numeral 20 denotes a virtual keyboard displayed on a display of computer glasses 10;
numeral 22 denotes a projector, for projecting the content displayed on the display of computer glasses 10, on a flat surface;
numeral 24 denotes a microphone embedded in a frame of computer glasses 10;
numeral 26 denotes a desktop computer;
numeral 28 denotes a memory card;
numeral 30 denotes a slot and circuitry, through which a memory can be added to a desktop computer connected to or embedded in the computer glasses 10;
numeral 32 denotes an Internet camera;
numeral 34 denotes a desktop computer embedded in a chip, such as a smart card;
numeral 36 denotes a USB connector in a frame of computer glasses 10;
numeral 38 denotes an RF (Radio Frequency) signal, such as a Bluetooth signal;
numeral 40 denotes an RF transceiver;
numeral 42 denotes a camera;
numeral 44 denotes external earphones connected to computer glasses 10 through a corresponding connector 52;
numeral 46 denotes a laptop computer, connected to computer glasses 10;
numeral 48 denotes a Bluetooth communication signal;
numeral 50 denotes a wireless network;
numeral 52 denotes an earphones connector;
numeral 54 denotes a cellular telephone;
numeral 56 denotes a cellular network;
numeral 58 denotes a cellular transceiver, embedded in computer glasses 10;
numeral 60 denotes built-in earphones; and
numeral 62 denotes a landmark device to be placed in front of a user.

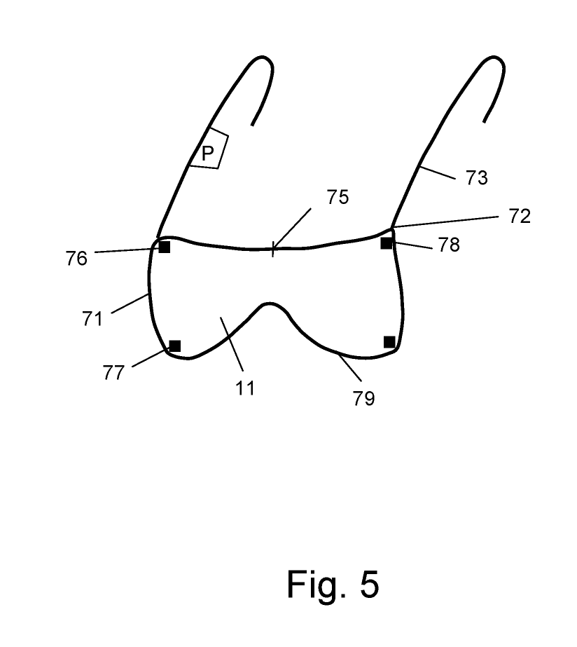

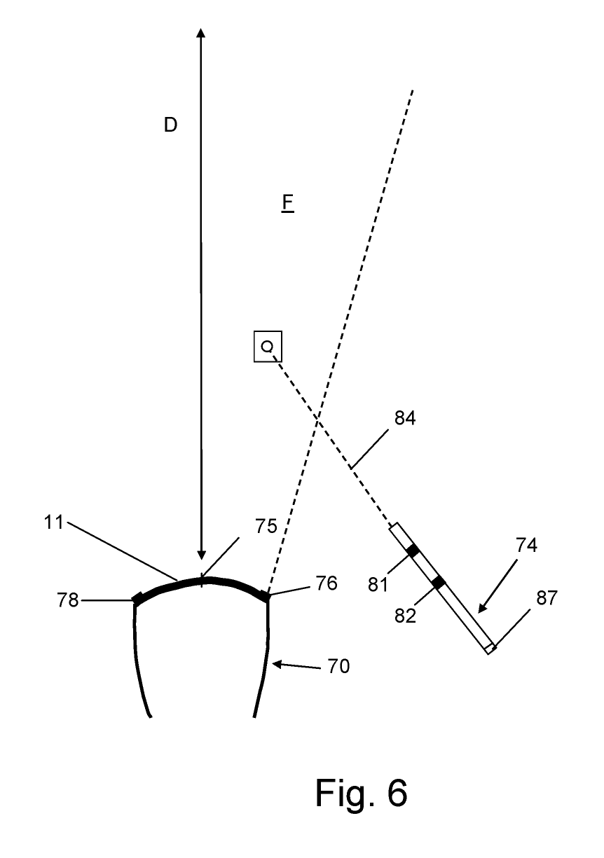

In another embodiment of the invention illustrated in FIGS. 5 and 6, computerized wearable glasses 70 operate in conjunction with an elongated pointing rod 74 to help a lecturer, for example, to select a real-world object viewed through glasses 70 within the lecture hall and to share the selected object with participants, whether located within the lecture hall or remotely viewing the lecture by a data connection, such as via the Internet. Processor P of computerized unit 15 (FIG. 1) is configured to integrate the selected object with the presentation. Thus the lecturer is afforded flexibility in displaying a viewed object during the course of a lecture that has not been previously included in a prepared presentation.

The prepared presentation may have been previously stored in a memory device of computerized unit 15. By manipulating hand mounted glove 12 (FIG. 1) comprising one or more sensors 14 in data communication with the computerized unit to interpret finger movements, the lecturer is able to advance slides or activate any desired presentation tool without need of accessing an external computer during the course of a lecture.

Alternatively, the prepared presentation may have been previously stored in a memory device of a computer 26 (FIG. 3) external to glasses 70. The lecturer may advance slides with use of an input device of computer 26 or with use of glove 12.

In order to facilitate the interaction of glasses 70 and pointing rod 74, three or more receivers 76-78 defining a reference plane with respect to an origin 75, e.g. located along the bridge of glasses 70, are embedded within or mounted on the frame, and are in data communication with the computerized unit. For example, receivers 76 and 77 are embedded within or mounted on a first rim 71 holding a lens 11 and receiver 78 is embedded within or mounted on a second rim 79. Each of the receivers may be positioned proximate to a corresponding hinge 72 pivotally connecting a temple 73 to a rim, to coincide with a borderline of a three-dimensional field of view F viewable through lens 11. Processor P of the computerized unit computes the three-dimensional field of view F, in accordance with the curvature and angle of view defined by lens 11, and along a predetermined distance D from origin 75.

Alternatively, the reference plane may be established by means of stationary landmark device 62 (FIG. 2).

At least two longitudinally spaced transmitters 81 and 82 are mounted within pointing rod 74. These transmitters define a vector 84 with respect to the reference plane in accordance with the instantaneous pointing direction of rod 74. Processor P thus determines whether a viewable real-world object O is selectable by the lecturer if (a) object O is located within field of view F, (b) vector 84 intersects field of view F, and (c) vector 84 coincides with object O.

A selection operation may be performed when the lecturer depresses button 87 at one end of rod 74, causing a visible beam to be emitted from the second end thereof and providing means of visual feedback to assist the lecturer in determining whether rod 74 was accurately oriented and the desired object O was properly selected. After a first predetermined time following emission of the beam of light, e.g. 3 seconds, forwardly directed camera 32 (FIG. 3) captures an image of object O and the computerized unit automatically projects the same on a screen or on any other flat surface in the lecture room. At the same time, the captured image may be transmitted via a communication channel to each remote user in data communication with the computerized unit.

Processor P will suppress operation of forwardly directed camera 32 if it is determined that vector 84 does not coincide with object O, or if the lecturer depresses button 87 within a second predetermined time, e.g. 2 seconds, which is less than the first predetermined time, after determining that the emitted beam did not strike object O, indicating that rod 74 was not properly oriented.

Processor P comprises an image processing module for identifying a selectable object that is located within field of view F and coincides with vector 84. The image processing module may be configured to identify a selectable object upon determining that it is characterized by a predetermined contrast between a borderline of the object and surrounding pixels.

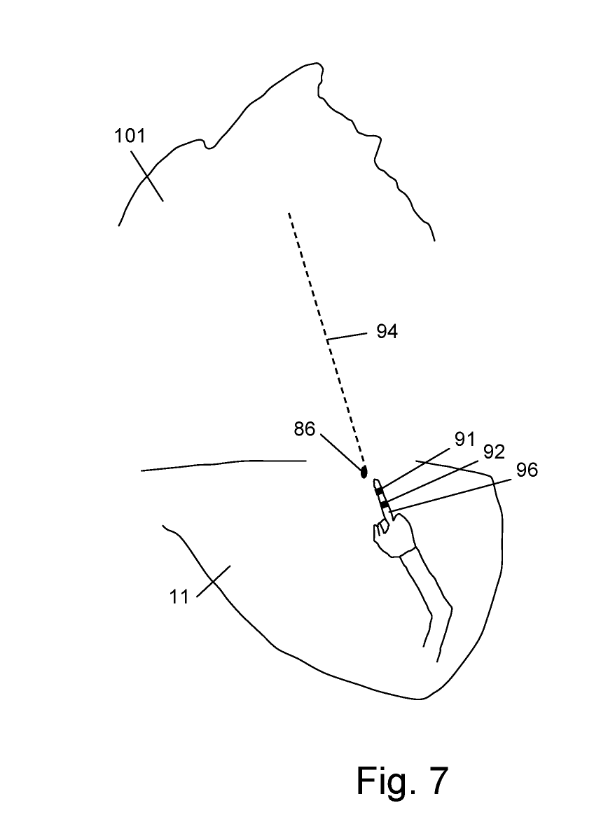

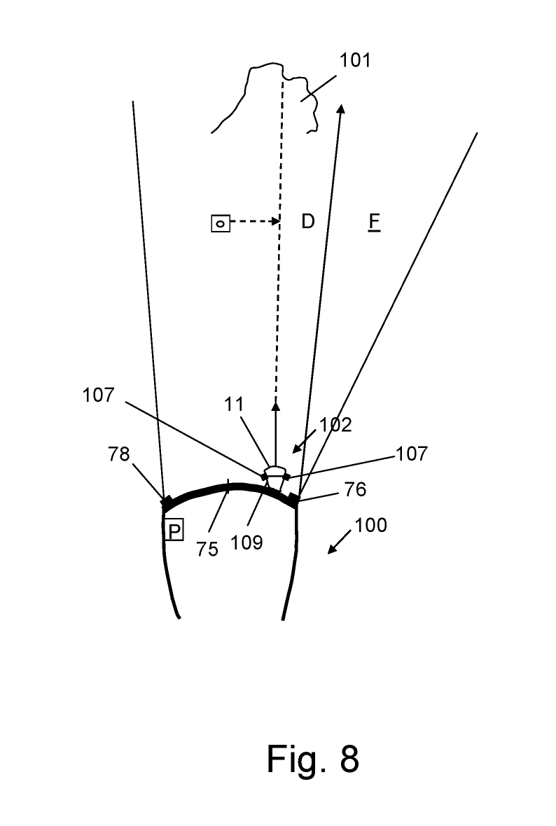

In another embodiment of the invention illustrated in FIGS. 7 and 8, a user in transit, such as a passenger, jogger or a cyclist, is able to select a viewed real-world object by a pointing gesture and to share the viewed object with a friend or with a colleague. In order to facilitate performance of a selection operation by the user in transit, at least two longitudinally spaced transmitters 91 and 92 are secured to index finger 96 of the user by corresponding fastening elements, such as an adhesive fastening element and a clasp, to define a vector 94 with respect to the reference plane in accordance with the instantaneous pointing direction of index finger 96. When the user views a distinctive object 101 through lens 11 of computerized glasses 100 that he or she wishes to share with others, e.g. the illustrated mountain, index finger 96 is pointed at object 101 in order to identify the viewable object to be shared. Processor P of the computerized unit may determine that a pointing operation has been carried out when index finger 96 is maintained at a pointing position for more than a predetermined time, e.g. of 4 seconds.

The user may receive visual feedback in response to the pointing operation, to determine whether the correct object was selected or whether the index finger was correctly positioned. The visual feedback may be generated by processor P together with other components of the computerized unit in the form of a spot of light 86 appearing on lens 11, at a portion thereof that is indicative to the user as to which viewed object was selected. The user may cancel the image capturing operation and repoint if it was determined that an incorrect object was selected.

Processor P is able to determine the relative position of transmitters 91 and 92 with respect to the reference plane, as defined by the glasses-mounted receivers, and is therefore able to determine the spatial coordinates of vector 94. To simulate the sighting procedure carried out by the user for selecting object 101 by aligning the pointing direction of index finger 96 with the instantaneous viewing direction of the user's eyes, depending on the angle of inclination with respect to a vertical plane and the azimuth angle with respect to a horizontal plane, the processor is programmed to identify an object 101 coinciding with vector 94 passing through infinite space. The image processing module helps the processor to identify an object upon determining a predetermined contrast between one or more of its border or contour lines and surrounding pixels, or by relying on any other image processing technique well known to those skilled in the art.

Processor P may be configured to filter out all objects that are located more than a predetermined distance D from origin 75, e.g. 300 m, within which distance real-world objects are clearly visible and capturable. If more than one object coinciding with vector 94 is spaced less than distance D from origin 75, the image processing module is generally configured to identify that object which is closer to origin. A second object may be known to be more spaced from the origin than a first object when its dimensions are smaller than the first object, or when some of its pixels are concealed by the first object.

After the processor has identified object 101, schematically illustrated, forwardly directed camera 102 needs to capture the object even though the user is in transit and the relative orientation of camera 102 with respect to the object will change between the time that the object was selected by index finger 96 and the object capturing time. To take into account the change of orientation of camera 102, computerized glasses 100 are provided with at least one camera-related orientation determining component 107. The camera-related orientation is determined with respect to the reference plane defined by the glasses-mounted receivers, including the illustrated receivers 76 and 78.

Each camera-related orientation determining component 107, preferably at least two components for ensuring good quality of captured images, may be configured as a transmitter mounted on a holder 109 of a swivel camera lens 111, or any other type of movable camera lens. After processor P has identified object 101 as the focus point, camera 102 is commanded to lock onto the focus point so that lens 111 will be suitably displaced in response to data received from orientation determining component 107 to ensure that object 101 remains in focus substantially at the center of lens 111 during subsequent movement of the user. Camera 102 remains locked lock onto the focus point until a single still picture is taken, or, depending on user input, until multiple still pictures are taken. During the capturing of video images, camera 102 will remain locked onto the focus point until the user selects another object by a subsequent pointing gesture, the object is spaced from the origin by more than predetermined distance D, or the object is spatially spaced from the origin at an angle that is beyond the tracking capabilities of lens 111.

It will be appreciated that camera 102 may remain locked lock onto the focus point when the lens is fixed and the camera is spatially displaceable relative to a base.

After an image is captured, the user may select a recipient with whom to share the captured image or images. A one-finger scrollable favorite contact list menu may be automatically displayed by the processor at a peripheral region of lens 11. The captured image is then wirelessly transmitted to the selected recipient who is generally remotely located, i.e. separated more than predetermined distance D from origin 75 within which distance real-world objects are clearly visible and capturable, and who may also be wearing computerized glasses on the lenses of which the transmitted image may be displayed. Other input commands to the computerized unit such as zoom or other image capturing parameter are also enterable by a one-finger scrollable menu.

Alternatively, input commands may be entered by voice command or by means of virtual keyboard 20 (FIG. 1), depending of course on whether the obstruction of the user's field of view is harmful or impairs performance of a desired task.

The wireless transmission of the captured image is carried out by transceiver 40 (FIG. 3), or alternatively by a transceiver mounted on a different bodily part such as a foot, or on a rigid inanimate element such as a bicycle handlebar, and in short-range communication with the computerized unit. If so desired, the computerized unit may also be separated from the glasses, as long as it is in short-range communication with forwardly directed camera 102.

A system incorporating a camera carried by the frame of computerized glasses renders one hand free for use in performing a pointing and image capturing operation. In conjunction with the camera-related orientation determining component, a user in transit can effortlessly capture images being viewed while, for example, hiking, riding a bicycle or talking with a group of friends. Thus a remote second user wearing another pair of glasses will then able to receive the captured images in real time and enjoy the event being viewed and relate to it with the first user. The pointing gesture is also useful, for example, when riding a bicycle whereby one hand holds the handlebar and the other hand is free to select the field of view to be captured by the camera.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A computerized wearable glasses system for communicating visual information, comprising:
i. at least one transparent optical lens adapted to display, whenever desired, visual content on at least a portion of said lens, for enabling a user wearing said glasses to see said visual content, wherein said lens enables said user to see therethrough, in an optical manner, also a real-world view;
ii. a wearable frame for holding said at least one lens;
iii. a portable computerized unit for generating said visual content and displaying or projecting said visual content on said lens portion, wherein said computerized unit is embedded within said frame or mounted thereon;
iv. a forwardly directed camera which is in data communication with said portable computerized unit and which is embedded within or mounted on said frame, for capturing remote real-world visual information viewed through said at least one optical lens;
v. an orientation determining component in data communication with said portable computerized unit, for locating a spatial position of said forwardly directed camera or of an element thereof;
vi. an element embedded within or mounted on said frame for establishing a connection between said computerized unit and a wireless interfacing communication channel, for wirelessly transmitting said captured real-world visual information;
vi. communication equipment in short-range data communication with said computerized unit for defining a local reference point or reference plane; and
vii. at least two longitudinally spaced transmitters in short-range data communication with said computerized unit which are positionable to define a vector with respect to said reference point or plane that is directable at a real-world object of interest,
wherein said computerized unit is responsive to orientation data of said forwardly directed camera received from said orientation determining component and to position data received from said at least two transmitters, to select and controllably adjust, when said at least two transmitters are arranged to point at said real-world object of interest, a field of view of said forwardly directed camera so as to include and lock onto said real-world object of interest even during subsequent movement of said user and to thereby capture real-world visual information that includes said object of interest,
wherein said captured real-world visual information is wirelessly transmittable over said communication channel to a desired recipient, is viewable by said recipient, whenever desired, and is changeable in response to said movement of said user.

2. The system according to claim 1, further comprising a rear camera embedded within or mounted on the frame, such that multimedia information showing at least a portion of a face of the user is capturable and wirelessly transmittable to the desired recipient.

3. The system according to claim 2, further comprising a projector embedded within or mounted on the frame, for projecting generated visual content on an essentially flat vertical surface in front of said computerized unit,
wherein the computerized unit, when positioned on a horizontal surface in front of the user in such a way that the rear camera captures the entire face of the user, is operable to transmit images of the face of the user to said projector so as to superimpose the face of the user on said generated visual content,
wherein images of the face of the user superimposed on said visual content are transmittable via the communication channel to other videoconferencing participants.

4. The system according to claim 1, further comprising at least one hand mounted sensor in data communication with the communication equipment for indicating a state and position of each of the fingers of the user, with respect to reference point or reference plane, so as to function as an input device for controlling operation of the forwardly directed camera and for selecting a destination to which the captured real-world visual information is to be transmitted.

5. The system according to claim 4, further comprising a keyboard substitute which includes a virtual keyboard displayed on the lens portion, wherein the at least one sensor is indicative of the state and position of each of the fingers of a user, with reference to an image that represents said virtual keyboard, thereby providing a user interface in the form of video glasses for the computerized unit.

6. The system according to claim 4, wherein the at least one sensor is embedded within a glove wearable by the user.

7. The system according to claim 1, further comprising one or more components selected from the group of;
a) built-in earphones, connected to the wearable frame, for being used as an output facility of the computerized unit;
b) a microphone embedded in the wearable frame, for being used as an input facility to the computerized unit;
c) a pointing device in wired or wireless communication with the portable computerized unit;
d) circuitry and/or computer code for analyzing human speech and translating thereof to computer instructions;
e) an I/O port and circuitry, for allowing connecting additional peripherals to the computerized unit; and
f) a memory slot and circuitry, for allowing connecting a memory to the computerized unit.

8. The system according to claim 1, wherein a substantial part of the circuitry of the portable computerized unit is embedded in an external device, said external device being connected to the computerized unit via a wired or wireless communication channel.

9. The system according to claim 1, wherein the at least one lens enable to see therethrough, in a digital manner, a real-world view.

10. The system according to claim 1, wherein the computerized unit is further adapted to generate stereoscopic images such that a different image is displayed to each eye, thereby allowing presenting 3D images.

11. The system according to claim 3, wherein the projected visual content is provided with a virtual input device.

12. The system according to claim 2, wherein the forwardly directed and the rear camera capture still images or video images.

13. The system according to claim 1, further comprising a cellular module, embedded in the wearable frame, thereby providing the computerized unit the ability of cellular communication.

14. The system according to claim 1, wherein the computerized unit is powered by one or more rechargeable batteries, said batteries being rechargeable by solar energy via a solar panel or manually via a charger with a manual hand ankle.

15. The system according to claim 11, wherein the virtual input device is selected from the group consisting of a virtual keyboard, a virtual computer mouse, the combination of a virtual keyboard and a virtual computer mouse, and at least one virtual glove.

16. The system according to claim 1, wherein the communication equipment comprises a plurality of receivers mounted on the frame for defining the reference plane.

17. The system according to claim 1, wherein the communication equipment comprises a landmark device spaced from, and in data communication with, the computerized unit, said landmark device comprising a transceiver and circuitry for defining the local reference point.

18. The system according to claim 1, further comprising at least one additional pair of glasses each of which is identical to, and remotely separated from, said computerized wearable glasses system, wherein said captured real-world visual information which is wirelessly transmittable is displayable on said at least one lens of each of said at least one additional pair.

19. A method for communicating visual information, comprising the steps of bodily mounting a pair of computerized glasses comprising a computerized unit, a forwardly directed camera which is in short-range data communication with said portable computerized unit, and communication equipment in short-range data communication with said computerized unit for defining a local reference point or reference plane; viewing a real-world object of interest; causing said computerized unit to identify said object by performing a pointing gesture, whereby at least two longitudinally spaced transmitters in short-range data communication with said computerized unit are positioned in such a way to define a vector with identifiable coordinates with respect to said reference point or plane and that is directed at said real-world object of interest; capturing an image of said object with said forwardly directed camera; and wirelessly transmitting said object over a communication channel from said computerized unit to a desired recipient.
